(19) United States
(12) Patent Application Publication
(10) Pub. No.: US 2011/0010201 A1
(43) Pub. Date: Jan. 13, 2011

(54) Method of managing contingent profits

(76) Inventor: Michael Mahan, Los Angeles, CA (US)

Correspondence Address: PETER F WEINBERG;GIBSON DUNN AND CRUTCHER LLP, SUITE 4200, 1801 CALIFORNIA STREET, DENVER, CO, 80202, US

(21) Appl. No.: 12/459,773

(22) Filed: Jul. 7, 2009

(51) Int. Cl. G06Q 40/00

(52) U.S. Cl. 705/4; 705/39

(57) ABSTRACT

A method of allocating the risk and reward of financial performance that is contingent upon the outcome of sporting events. The business and a second party enter into a contract under which the second party guarantees all or a portion of certain profits to the business that are otherwise contingent upon the sporting event outcome, in exchange for a fee.

### FIELD OF THE INVENTION

The present invention relates to a method and system for managing profits that are contingent upon the outcome of sporting events.

### BACKGROUND OF THE INVENTION

Sporting events have long been subjects of financial investment. In the crudest form, such investments are simple wagers, where two or more persons bet on the outcome of an event. Sometimes this is accomplished through an intermediary. Sometimes the bets are handicapped by odds or point spreads that are determined dynamically in the betting market.

The proliferation of financial instruments has led to forms of financial investments related to sporting events that are much more sophisticated than mere wagers. For example, U.S. patent application 2002/0069161 describes a system in which an athlete can issue notes in which a payment obligation is partially contingent upon the athlete attaining certain performance milestones. The athlete himself may have a contract with his team whereby his own salary includes bonuses that are contingent upon his attaining certain performance statistics or similar measurable milestones. The net effect of such an arrangement is that the athlete “hedges” or . spreads the risk of his failure to attain the identified milestones, in return for sharing the profit if he does attain those milestones. Looked at another way, the athlete enters into a contract to protect against his financial loss in not attaining the milestone, the price of which is a share of his profits if he does attain such milestones.

Similar arrangements can be devised outside the field of athletics, such as in entertainment or other fields where a performer's compensation is directly tied to measurable performance criteria.

It will be appreciated that such arrangements can be traded in the manner of a security. The value of the holder's interest would fluctuate in response to the likelihood, as perceived by the market, that the athlete will attain the performance milestones upon which the payment to the holder is contingent.

Outside athletics, the financial world sometimes characterizes these sort of arrangements as a hedge contract for addressing “idiosyncratic” risk. Such arrangements fall under the more general category of “derivatives” in which the security value is derivative of the value of some underlying security or other obligation. See, for example U.S. patent application 2006/0136316 and U.S. Pat. No. 7,206,755.

### SUMMARY OF THE INVENTION

In one embodiment, the present invention is a financial derivative instrument and method of utilizing the same. More specifically, a business enterprise, such as a restaurant or bar, whose operational business is affected by the outcome of sporting events, enters into a contract under which it agrees to make certain payments to the other party to the contract (an “obligor”) upon a specified outcome to a sporting event. In this example, the operational business of a restaurant or bar may be negatively impacted by an undesirable outcome in several ways. If the establishment caters to local clientele who follow a particular team, an early playoff loss by that team may have a devastating impact on profits, given that local fans will be far less likely to frequent the restaurant or bar to watch teams other than the “home team” compete for the championship. Another variable is not whether the “home team” wins, but how they win. A restaurant or bar will reap significantly greater profits if games are competitive late into the contest, or if a playoff series lasts the maximum number of games, thereby giving patrons a reason to arrive often and stay longer, resulting in increased sales.

The method is useful for businesses to spread the risk associated with events over which they have no control or limited control such as an athletic contest. As noted above, a first party to a contract, such as a restaurant or bar in proximity to a sporting locale such as a stadium or arena, can partially hedge against the downturn in profits resulting from the local sports teams' failure to enter or advance in the playoffs. The restaurant or bar owner achieves this by means of a contract entered into with a second party. The second party agrees to pay the restaurant or bar owner a fee. In return, the bar or restaurant owner agrees to pay the second party a payment that is contingent upon a specified outcome of the identified sporting event—typically the advancement of a local team. Note that another formulation is to have the owner pay the fee and the second party make the payment, which achieves the same result. The payment by the restaurant or bar owner may be related to its increased profits resulting from the occurrence of the specified event, such as increased food and beverage sales results from increased patronage during the local team's successful run. In a simple form, the restaurant or bar owner agrees to pay the other party to the contract a percentage of profits or revenues realized during the local team's successful run in exchange for an agreement by the second party to limit the financial risk associated with the local team's failure to advance. Types of payments may include an actual profit percentage, or a profit with a minimum guarantee or fixed amount (which may or may not be a profit stream with a minimum guarantee with the “upside” stripped out).

In this manner, a business establishment whose profits are partially dependent upon desired outcomes to sporting events protects against undesirable outcomes by selling a portion of its profits resulting from a desired outcome.

Another approach embodying the invention is for a first party such as a merchandise vendor to enter into a contract with a second party to sell merchandise, the value of which is contingent upon the sporting event outcome. The price is something less than the first party believes it could command in the event the sporting event has one outcome, but is more than the first party expects to command in the event the sporting event has the opposite outcome. In this way, the first party “hedges” against the risk of an adverse outcome that would leave it with an inventory of useless merchandise. The second party in effect ensures the first party against that risk in exchange for a discounted price on the merchandise. The degree of discount is negotiated between the parties, taking into consideration their respective views as to the likelihood of an adverse outcome.

Although the Detailed Description below sets forth several embodiments of the invention in the context of particular circumstances, it should be appreciated that the invention is applicable to any arrangement in which the risk to a business resulting from particular sporting even outcomes is allocated, hedged or insured against.

### DETAILED DESCRIPTION OF THE INVENTION

The invention is described in detail below with reference to the figures. The invention is primarily but not exclusively applicable to businesses whose profits are dependent upon the outcome of particular sporting events. Examples of such businesses abound, and include:

National and local television broadcasters;

National and local radio broadcasters;

Sporting venues (stadiums and arenas);

Restaurants;

Team Owners Municipalities Sports bars;

Ticket brokers;

Publications;

Hotels;

Managed services;

Concessionaires;

Parking lot operators;

Advertisers;

DVD/Home Video;

Security Firms. Further, the invention is applicable to various risks, described in part below:

The risk that a playoff or other series will last fewer than the maximum number of games;

The risk that one or both of the teams competing for a championship are from a “small market” with a relatively small fan base.

The risk that a particular team or player loses early in (or does not qualify for entry into) a tournament, playoff or series.

The risk that a particular game will be so lopsided that fans lose interest early.

A first step in the method of the present invention is to identify a business whose profits are affected by the outcomes of sporting events. In the simplest form of the invention this “desired outcome” is a win or a set of wins by the local team, but scenarios can be imagined where a desired outcome for a particular business could be a loss. For example, retail clothing stores sometimes experience a decline in sales when a local team is playing important games, because their potential customers are watching the event in person or on television rather than frequenting the clothing store.

The next step is to identify a particular sporting event, the outcome of which will affect the profits of the identified business. Generally, such an event will be something like the World Series, Super Bowl, World Cup, or March college basketball playoffs, or the many post-season playoff contests through which the participants in these events are selected. Regular non-playoff games may also generate sufficient fan interest to warrant the invention.

The next step is to quantify the effect of particular outcomes of the identified sporting event on the profits of the identified business. This can be quite difficult. For business establishments that have operated during such events in the past, the qualification step can be calculated empirically. That is, the financial impact can be estimated based on the business establishment's experiences with such events in the past, with adjustments to account for such things as the precise nature of the event (such as multi-game World Series versus a single game Super Bowl) and different circumstances (such as an expanded or contracted fan base relative to the previous event that serves as the empirical baseline).

For many establishments, the desired outcome produces a financial return that is a predictable maximum. For example, a parking facility will hold an ascertainable number of cars. The desired outcome will completely fill the facility, producing a predictable maximum revenue. Similarly, restaurants and bars are limited by practical considerations and by local ordinances to a maximum occupancy. The expenditures of the average occupant is predictable, and so the maximum revenue and profits are reasonably predictable. Once this maximum is reached, it cannot be exceeded even if the fan excitement increases. Such establishments, therefore, may see similar financial results from the first game of the World Series and the final game of the World Series.

Continuing with the World Series example, the winner of that event is the team to win the best of a seven game series. It might be determined that a restaurant in the same city as one of the two teams participating in the World Series could expect to realize profits of $25,000 beyond its usual profits, for each World Series game. The restaurant could earn this $25,000 figure as many as four times if the World Series extends to seven games (rather than one team or the other winning the requisite four games in only four, five or six games). The first of these four events is guaranteed; the World Series cannot be won without at least one of those four games being played. The other three events are contingent; they will occur only if the other team wins one or more games.

The next step is to structure the payment arrangement. The same restaurant is guaranteed to generate $100,000 during the course of the World Series (because the World Series will last a minimum of four games), and could generate as much as $175,000 during the course of the World Series in the event the World Series lasts the maximum seven games), representing a $75,000 differential between the “best case” and “worst case” scenarios. One possible payment arrangement would be for the restaurant to transfer to obligor all of the risk associated with the number of games to be played in exchange for a guaranteed payment of less than $75,000.

In return for agreeing to make these guaranteed payments, the second party to the contract receives the right to receive some or all of the restaurant owner's profits attributable to each game The contract could be structured as a complete or partial hedge, such that the second party may be entitled to receive 100% of the profits attributable to each marginal game, or some portion thereof.

The next step is to price the contract. In this step, the parties agree upon the price to be paid by the restaurant for the privilege of enjoying a contractual right to receive some or all of his contingent profits, regardless of whether the contingent event occurs.

Most commonly, the price of a contract will be based on the probability that a particular outcome which triggers payment under the contract will occur. The probability of the particular outcome can be determined intuitively, empirically, mathematically, or otherwise through the use of general sports handicapping methods, whereby a person or group of persons (with or without the assistance of a computer) gather various data points regarding a player or team (including but not limited to statistical data, historical data, actual or perceived strengths and weaknesses of the participants, general observations, “gut feelings,” etc.) and analyze such data to arrive at a conclusion regarding the likelihood of a particular outcome (whether by employing “Monte Carlo” or other multiple-simulation methodology or otherwise). The above-described process may be referred to colloquially as “odds making;” i.e., any process by which a person arrives at a generalized conclusion regarding the likelihood of a particular outcome to a sporting event through the analysis of one or more particular facts or beliefs about the participants or circumstances surrounding the sporting event.

In another example, a television network may hold the rights to broadcast the World Series. The network may realize, for example, a net profit of $25,000,000 for each game that the World Series extends past four games. So it realizes $50,000,000 in incremental profit if the World Series lasts for six games, and $75,000,000 if it lasts for seven games. Another party could enter into a contract with the television network whereby the television network assigns to the other party this incremental profit of $25,000,000 per game in excess of four in exchange for a predetermined fee. The fee is agreed upon by the parties based on their respective perceptions of the probabilities that the World Series will extend beyond four games, beyond five games, and beyond six games.

Another example is drawn from the circumstance where the occurrence and duration of the event is not in doubt, but the outcome is. Before a final event such as the final game that determines a championship, merchandise is typically manufactured to memorialize a win. If indeed the outcome is a win, then the merchandise is sold. If, on the other hand, the outcome is a loss, then the merchandise is destroyed.

The merchandise is often manufactured by smaller companies who can ill afford the risk that the outcome will require a destruction of the souvenirs. In that event, the manufacturer can sell to a second party the right to the profits that would be earned on the merchandise. For example, the profits might amount to $500,000 if the outcome is the desired one (and 0 if it is not).

The price that the second party pays for the right to receive this $500,000 contingent profit is based on the perceptions of the probability of a desired outcome. If the second party perceives that probability to be 60%, for example, then it might be willing to pay something less than 60% multiplied times the contingent profit of $500,000. If the agreed-upon price is, say, $264,706, then the obligor will hold a contractual right that (at least based on its personal perception of the relevant probabilities) is worth the difference between the statistical value of $300,000 (60% times $500,000) and $264,706, for a value of $35,294. Even if the company and the second party perceive the relevant probabilities identically, the company may be willing to enter into such arrangement because of its value as a hedge.

Of course, it is entirely possible that the outcome will be the undesired one; in circumstances where the desired outcome has a 60% probability of happening, it fails to happen 40% of the time. However, these aberrant events should average out over the course of numerous transactions if the pricing estimates accurately reflect the true probabilities.

Another way in which to practice the invention is for the second party to agree in advance to purchase from the company tangible goods or a legal right. For example, the second party could agree to purchase from a broadcast company all or some portion of the advertising rights for the sixth game of the World Series, in exchange for an agreed-upon fee that is something less than the value of such advertising rights, together with the right to sell such rights back to the broadcaster at a higher price in the event the World Series goes to six games. If the World Series does not go to a sixth game, then the broadcast company will still realize some or all of the profits that it would have realized if it had. If the World Series does go to six games, then the broadcaster will still have the advertising rights by having repurchased them from the obligor at a price higher than the price for which it previously sold them to the second party. The difference between the price for which the obligor purchased the rights, and the price at which the obligor re-sells them to the broadcaster, is a function of the parties' respective perceptions of the probability that the World Series will go to six games along with their perception of the value of the hedge obtained by the broadcaster. In formal jargon, this sort of arrangement is sometimes called a “put” whereby the owner of a right or property has the right to require another party to purchase that right or property in the future at a fixed or determinable price.

The “put” approach can be used in other contexts as well. In merchandising, the obligor can agree to purchase from a manufacturer a quantity of merchandise such as souvenir memorabilia that has a value only if a particular outcome occurs, together with the right to “put” the merchandise back to the manufacturer at a higher price in the event that the outcome does indeed occur.

In “put” arrangements, the rights of both the company and the obligor may be sold or even exchanged in a market whereas their values vary over the passage of time and the occurrence of events affecting the probabilities of the outcome upon which the arrangement is based.

The calculations, pricing and “addmaking” steps described herein may be performed by or with the assistance of a computer. Some of the calculations may be complex. A non-limiting example is set forth in Exhibit A attached hereto and incorporated by reference herein.

What is claimed is:

1. A method for allocating risk and reward of financial circumstances that are contingent upon sporting event outcomes, comprising:
(a) identifying a business whose profits are contingent upon a sporting event outcome, which sporting event has at least a first potential outcome and a second potential outcome;
(b) quantifying the extent to which such profits are contingent upon said sporting event outcomes; and
(c) establishing a contract between said business and a second party, whereby the business assigns to the second party a discrete interest in the profits of the business which are contingent upon said sporting event outcomes, and the second party agrees to pay to the business amounts that are based at least in part upon the expected profit resulting from one of said outcomes.

2. The method of claim 1, wherein said contract also provides that one of the business or the second party pays to the other a fee for said contract.

3. The method of claim 2, wherein at least one of said fee and said amounts are calculated based at least in part upon the probability of said outcomes.

4. The method of claim 3, wherein the probability of said outcomes is calculated using sports handicapping methods, whereby a computer analyzes one or more data points with respect to a player(s) or team (including statistics) to determine the likelihood of a particular outcome.

5. The method of any of claims 1, 2, or claim 3, wherein (a) the business and the second party are insured and insurer; (b) the contract is an insurance contract; and (c) the amount payable by the business is an insurance premium, and the amount payable by second party is a coverage amount.

6. The method of any of claims 1, 2, or claim 3, wherein (a) the business and the second party are indemnitee and indemnitor; (b) the contract is an indemnity contract; and (c) the amount payable by business is a premium for indemnification.

7. The method of each of claim 1, claim 2, and claim 3, wherein (a) the business and second party are party and counterparty; (b) the contract is a contract to buy or sell tangible goods with respect to a property whose value will fluctuate as a result of the outcome of a particular sporting event; (c) the amount payable by the business or second party is a strike price;
(d) the probability of said outcomes is calculated by an analyst.

8. The method of claim 1, further comprising selling rights or any subset of such rights in said contract to a purchaser or purchasers.

9. The method of claim 7, further comprising trading rights in said contract on a trading exchange.
